(19) United States
(12) Patent Application Publication
(10) Pub. No.: US 2023/0194562 A1
(43) Pub. Date: Jun. 22, 2023

(54) INFORMATION PROCESSING DEVICE, INFORMATION PROCESSING METHOD, AND PROGRAM

(71) Applicant: Sony Group Corporation, Tokyo (JP)

(72) Inventors: Masato KITA, Kanagawa (JP); Taishu IWAMI, Kanagawa (JP); Masatsugu ISHIKO, Kanagawa (JP)

(73) Assignee: Sony Group Corporation, Tokyo (JP)

(21) Appl. No.: 18/017,778

(22) PCT Filed: Jul. 15, 2021
(86) PCT No.: PCT/JP2021/026706

§ 371 Date: Jan. 24, 2023

(30) Foreign Application Priority Data
Jul. 31, 2020 (JP) 2020-129852

(51) Int. Cl. G01P 13/00

(52) U.S. Cl. CPC G01P 13/00

(57) ABSTRACT

In a behavior measurement device (20a) (information processing device), a linear movement detection unit (44) determines, based on a position (P) of a user (90) measured at a predetermined time interval, whether or not the user (90) is linearly moving and detects a movement amount and a movement direction (θ₀) of a linear movement of the user (90). A rotational movement detection unit (42) detects an amount of change in an orientation of the user (90). Then, in a case where it is determined that the user (90) is linearly moving, an orientation calculation unit (43) calculates an orientation (θ) of the user (90) at a position where the user (90) is determined to be linearly moving based on a detection result of the rotational movement detection unit (42).

### FIELD

The present disclosure relates to an information processing device, an information processing method, and a program.

### BACKGROUND

Conventionally, a case of analyzing a behavior of a customer by detecting a position and an orientation of a user has been proposed.

### CITATION LIST

### Patent Literature

Patent Literature 1: JP 6012204 A

### SUMMARY

### Technical Problem

In Patent Literature 1, the traveling direction and the position information of the user are calibrated at the timing when the user passes through the ticket gate whose position is known in advance.

However, there is a problem that it is difficult to accurately detect the position and the orientation of the user in a state where there is no limitation on the movement route like the ticket gate.

The present disclosure proposes an information processing device, an information processing method, and a program capable of accurately detecting a position and an orientation of a user even in a state where there is no limitation on a movement route.

### Solution to Problem

To solve the problems described above, an information processing device according to an embodiment of the present disclosure includes: a linear movement detection unit that, based on a position of a user measured at a predetermined time interval, determines whether or not the user is linearly moving and detects a movement amount and a movement direction of a linear movement of the user; a rotational movement detection unit that detects an amount of change in an orientation of the user; and an orientation calculation unit that, in a case where the linear movement detection unit determines that the user is linearly moving, calculates the orientation of the user at a position where the linear movement detection unit determines that the user is linearly moving based on a detection result of the rotational movement detection unit.

### BRIEF DESCRIPTION OF DRAWINGS

FIG. 1 is a block diagram illustrating an example of a schematic configuration of a behavior measurement system of a first embodiment.

FIG. 2 is a block diagram illustrating an example of a hardware configuration of a mobile terminal of the first embodiment.

FIG. 3 is a block diagram illustrating an example of a hardware configuration of a behavior measurement device of the first embodiment.

FIG. 4 is a functional block diagram illustrating an example of a functional configuration of the behavior measurement device of the first embodiment.

FIG. 5 is a diagram illustrating an example of an application scene of the behavior measurement system of the first embodiment.

FIG. 6 is a first diagram for describing a method of detecting linear movement.

FIG. 7 is a second view for describing a method of detecting linear movement.

FIG. 8 is a diagram for describing a method of detecting an orientation of a user.

FIG. 9 is a flowchart illustrating an example of a flow of processing performed by the behavior measurement system of the first embodiment.

FIG. 10 is a flowchart illustrating an example of a flow of linear movement detection processing.

FIG. 11 is a diagram illustrating an outline of learning processing performed by a behavior measurement device of a second embodiment.

FIG. 12 is a functional block diagram illustrating an example of a functional configuration of the behavior measurement device of the second embodiment.

FIG. 13 is a flowchart illustrating an example of a flow of processing performed by the behavior measurement system of the second embodiment.

FIG. 14 is a diagram illustrating an outline of learning processing performed by a behavior measurement device of a third embodiment.

FIG. 15 is a functional block diagram illustrating an example of a functional configuration of the behavior measurement device of the third embodiment.

FIG. 16 is a flowchart illustrating an example of a flow of linear movement detection processing performed by the behavior measurement system of the third embodiment.

### DESCRIPTION OF EMBODIMENTS

Hereinafter, embodiments of the present disclosure will be described in detail with reference to the drawings. Note that, in each of the following embodiments, the same parts are denoted by the same reference numerals, and redundant description will be omitted.

In addition, the present disclosure will be described according to the following item order.

1. First Embodiment

1-1. Outline of behavior measurement system

1-2. Hardware configuration of behavior measurement system

1-3. Functional configuration of behavior measurement device

1-4. Operation of behavior measurement device

1-5. Method of calculating movement direction

1-6. Method of calculating orientation

1-7. Flow of processing performed by behavior measurement device

1-8. Effects of first embodiment

2. Second Embodiment

2-1. Outline of behavior measurement device

2-2. Functional configuration of behavior measurement device

2-3. Flow of processing performed by behavior measurement device

2-4. Effects of second embodiment

3. Third Embodiment

3-1. Outline of behavior measurement device

3-2. Functional configuration of behavior measurement device

3-3. Flow of processing performed by behavior measurement device

3-4. Effects of third embodiment

4. Application examples of present disclosure

### 1. First Embodiment

[1-1. Outline of Behavior Measurement System]

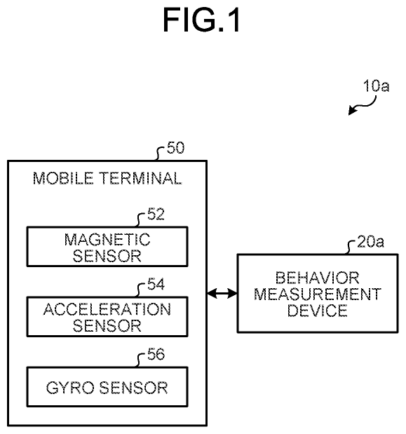

First, an outline of a behavior measurement system 10a to which the present disclosure is applied will be described with reference to FIG. 1. FIG. 1 is a block diagram illustrating an example of a schematic configuration of a behavior measurement system of a first embodiment.

As illustrated in FIG. 1, the behavior measurement system 10a includes a behavior measurement device 20a and a mobile terminal 50.

The behavior measurement device 20a measures the motion of the user who carries the mobile terminal 50. Note that the motion of the user measured by the behavior measurement device 20a is time-series information including the current position of the user and the direction (orientation) in which the user faces.

The mobile terminal 50 is carried by the user and detects information related to movement of the user. The mobile terminal 50 includes a magnetic sensor 52, an acceleration sensor 54, and a gyro sensor 56. The mobile terminal 50 is, for example, a smartphone.

The magnetic sensor 52 outputs the position (x, y, and z) of the magnetic sensor 52 using magnetic force. For example, the magnetic sensor 52 may detect the relative position from the source coil by detecting magnetism generated by the source coil. In addition, the magnetic sensor 52 may detect the absolute position of the magnetic sensor 52 by detecting geomagnetism. In general, a previously measured magnetic map or geomagnetic map is prepared, and the current position is detected by collating the measurement result of the magnetic sensor 52 with the magnetic map or the geomagnetic map.

As the magnetic sensor 52, sensors based on various measurement principles have been proposed, and any of them may be used. For example, the magnetic sensor 52 may detect a magnetic state by detecting a Hall voltage generated when a magnetic field is applied to the Hall element. In addition, the magnetic sensor 52 may detect a magnetic state by detecting a change in electric resistance when a magnetic field is applied to the MR element.

Note that mobile terminal 50 may have another positioning function instead of the magnetic sensor 52. For example, positioning may be performed by incorporating a global positioning system (GPS) receiver in the mobile terminal 50. In addition, positioning may be performed based on radio field intensity received from a Wi-Fi (registered trademark) router, a Bluetooth beacon, and the like installed at a known position.

The acceleration sensor 54 detects acceleration generated in the mobile terminal 50. Note that the acceleration is a vector amount having a magnitude and an orientation. The acceleration sensor 54 is, for example, a sensor that measures acceleration by detecting a change in electric resistance of a strain gauge and the like. The behavior measurement device 20a improves processing efficiency by using the output of the acceleration sensor 54 when detecting the current position of the mobile terminal 50 based on the output of the magnetic sensor 52. For example, since the current position of the magnetic sensor 52 is near a position obtained by adding a value based on the magnitude and direction of the acceleration detected by the acceleration sensor 54 to the previous position of the mobile terminal 50 detected by the magnetic sensor 52, it is possible to more efficiently detect the current position of the mobile terminal 50 by referring to the output of the acceleration sensor 54.

The gyro sensor 56 detects an angular velocity ω generated in the mobile terminal 50. The gyro sensor 56 is, for example, a vibration gyro. The vibration gyro detects the angular velocity ω based on the Coriolis force applied to the vibrating object. The angular velocity ω represents a degree of change in the orientation when the object rotates and moves, that is, a change rate of the orientation. Note that the gyro sensor 56 is a so-called differential sensor that outputs a signal only when the angular velocity ω is generated. The behavior measurement device 20a calculates the amount of change in the orientation of the mobile terminal 50 in which the gyro sensor 56 is incorporated by integrating the output of the gyro sensor 56 transmitted from the mobile terminal 50, that is, the angular velocity ω. Details will be described later. Note that the mobile terminal 50 itself may integrate the output of the gyro sensor 56, calculate the orientation of the mobile terminal 50, and transmit the calculated orientation to the behavior measurement device 20a. Note that, when the current position of the mobile terminal 50 is detected, the output of the gyro sensor 56 is also used similarly to the output of the acceleration sensor 54 described above. Thus, the efficiency of the processing of detecting the current position can be improved.

Note that, in FIG. 1, the behavior measurement device 20a is connected to only one mobile terminal 50, but the behavior measurement device 20a may be connected to a plurality of mobile terminals 50. Then, the behavior measurement device 20a can simultaneously measure motions of a plurality of users who carries the mobile terminal 50. In that case, the mobile terminal 50 transmits identification information for identifying itself and an output of each sensor described above to the behavior measurement device 20a. In addition, the mobile terminal 50 itself may be configured to incorporate the behavior measurement device 20a.

In addition, the magnetic sensor 52, the acceleration sensor 54, and the gyro sensor 56 described above may be incorporated in an accessory such as a wearable device or a key holder.

[1-2. Hardware Configuration of Behavior Measurement System]

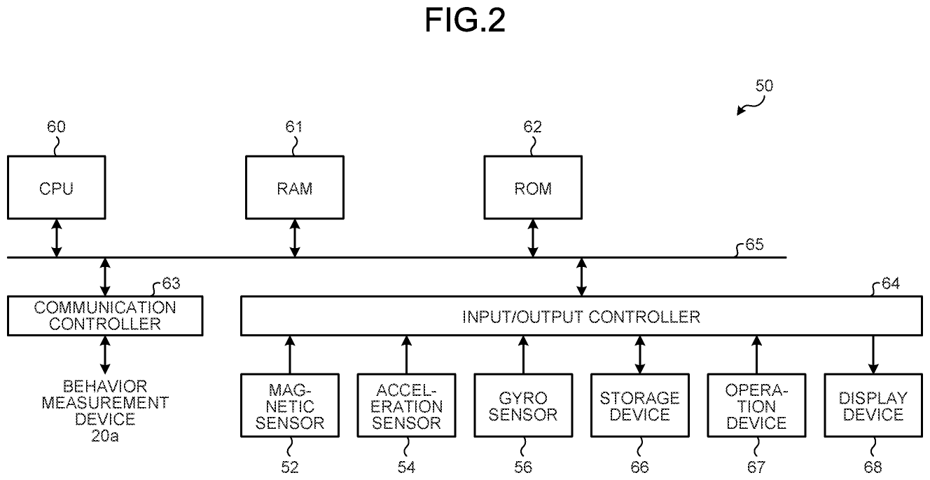

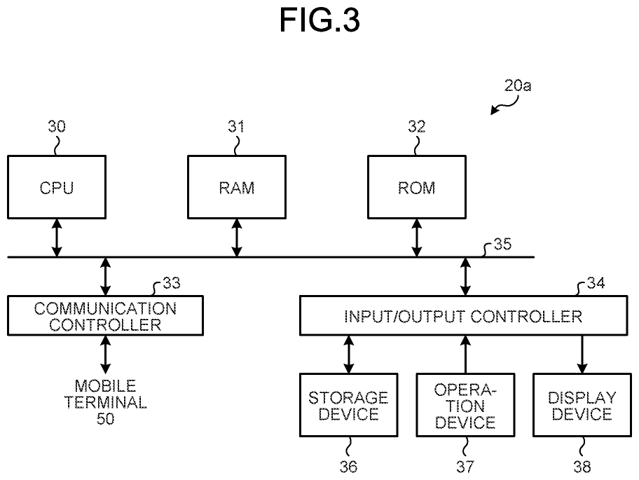

Next, a hardware configuration of the behavior measurement system 10a of the first embodiment will be described with reference to FIGS. 2 and 3. FIG. 2 is a block diagram illustrating an example of a hardware configuration of a mobile terminal of the first embodiment. FIG. 3 is a block diagram illustrating an example of a hardware configuration of a behavior measurement device of the first embodiment.

The mobile terminal 50 has a configuration in which a central processing unit (CPU) 60, a random access memory (RAM) 61, a read only memory (ROM) 62, a communication controller 63, and an input/output controller 64 are connected by an internal bus 65.

The CPU 60 controls the entire operation of the mobile terminal 50 by developing a control program stored in the ROM 62 on the RAM 61 and executing the control program. That is, the mobile terminal 50 has a configuration of a general computer that operates by a control program. Note that the control program may be provided via a wired or wireless transmission medium such as a local area network, the Internet, or digital satellite broadcasting. In addition, the mobile terminal 50 may execute a series of processings by hardware. Note that the control program executed by the CPU 60 may be a program in which processing is performed in time series in the order described in the present disclosure, or may be a program in which processing is performed in parallel or at necessary timing such as when a call is made.

The communication controller 63 communicates with the behavior measurement device 20a by wireless communication. More specifically, the communication controller 63 transmits outputs of various sensors acquired by the mobile terminal 50 to the behavior measurement device 20a.

The input/output controller 64 connects the CPU 60 and various input/output devices. Specifically, the magnetic sensor 52, the acceleration sensor 54, and the gyro sensor 56 described above are connected to the input/output controller 64. In addition, a storage device 66 that temporarily stores the output of the sensor is connected to the input/output controller 64. Furthermore, an operation device 67 such as a touch panel that gives an operation instruction to the mobile terminal 50 and a display device 68 such as a liquid crystal monitor that displays information are connected to the input/output controller 64.

In addition, the behavior measurement device 20a has a configuration in which a CPU 30, a RAM 31, a ROM 32, a communication controller 33, and an input/output controller 34 are connected by an internal bus 35.

The CPU 30 controls the entire operation of the behavior measurement device 20a by developing a control program stored in the ROM 32 on the RAM 31 and executing the control program. That is, the behavior measurement device 20a has a configuration of a general computer that operates by a control program. Note that the control program may be provided via a wired or wireless transmission medium such as a local area network, the Internet, or digital satellite broadcasting. In addition, the behavior measurement device 20a may execute a series of processings by hardware. Note that the control program executed by the CPU 30 may be a program in which processing is performed in time series in the order described in the present disclosure, or may be a program in which processing is performed in parallel or at necessary timing such as when a call is made.

The communication controller 33 communicates with the mobile terminal 50 by wireless communication. More specifically, the communication controller 33 receives outputs of various sensors from the mobile terminal 50.

The input/output controller 34 connects the CPU 30 and various input/output devices. Specifically, a storage device 36 that temporarily stores outputs of various sensors received from the mobile terminal 50 is connected to the input/output controller 34. Furthermore, an operation device 37 such as a touch panel and a keyboard that gives an operation instruction to the behavior measurement device 20a and a display device 38 such as a liquid crystal monitor that displays information are connected to the input/output controller 34.

[1-3. Functional Configuration of Behavior Measurement Device]

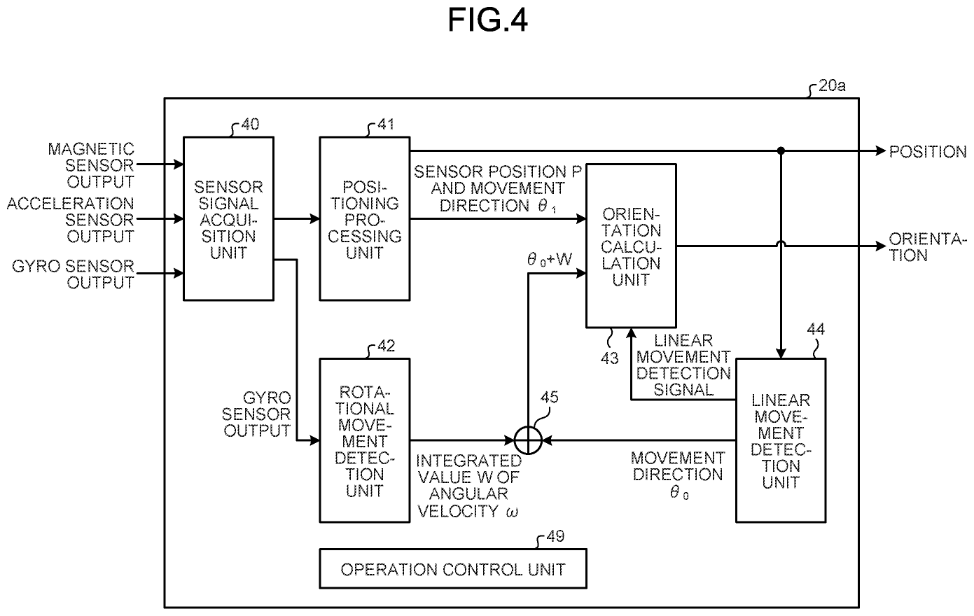

Next, a functional configuration of the behavior measurement device 20a of the first embodiment will be described with reference to FIG. 4. FIG. 4 is a functional block diagram illustrating an example of a functional configuration of the behavior measurement device of the first embodiment. The CPU 30 of the behavior measurement device 20a develops the control program on the RAM 31 and operates the control program, implementing a sensor signal acquisition unit 40, a positioning processing unit 41, a rotational movement detection unit 42, an orientation calculation unit 43, a linear movement detection unit 44, an addition unit 45, and an operation control unit 49 illustrated in FIG. 4 as functional units.

The sensor signal acquisition unit 40 acquires outputs of the magnetic sensor 52, the acceleration sensor 54, and the gyro sensor 56 from the mobile terminal 50.

The positioning processing unit 41 detects the current position of the mobile terminal 50, that is, a user 90. Specifically, the positioning processing unit 41 detects the current position of the mobile terminal 50 based on the output of the magnetic sensor 52, the output of the acceleration sensor 54, and the output of the gyro sensor 56 acquired by the sensor signal acquisition unit 40. The detected current position of the mobile terminal 50 is stored in the storage device 36 in association with the time when the current position is acquired. The storage device 36 functions as a first-in first-out (FIFO) memory. That is, the storage device 36 stores a predetermined number (predetermined time range) of positions of the mobile terminal 50. Details will be described later.

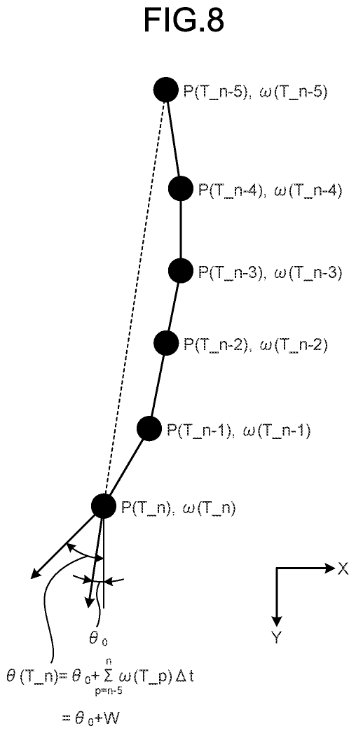

The rotational movement detection unit 42 detects an amount of change in the orientation of the mobile terminal 50. Specifically, the rotational movement detection unit 42 calculates an integrated value of the angular velocity ω output from the gyro sensor 56 of the mobile terminal 50. A method of calculating the integrated value of the angular velocity ω will be described later in detail (see FIG. 8). Note that, since the mobile terminal 50 is carried by the user 90, the integrated value of angular velocity ω of the mobile terminal 50 detected by the rotational movement detection unit 42 coincides with the amount of change in the orientation of the user 90.

In a case where it is determined that the user 90 is linearly moving based on the detection result of the linear movement detection unit 44, that is, in a case where a linear movement detection signal to be described later is input from the linear movement detection unit 44, the orientation calculation unit 43 calculates the orientation of the user 90 at a position where the user 90 is determined to be linearly moving based on the movement direction of the user 90 and the integrated value of the angular velocity ω detected by the rotational movement detection unit 42. A specific method of calculating the orientation of the user 90 will be described later (see FIG. 8).

In addition, in a case where the linear movement detection unit 44 does not determine that the user 90 is linearly moving, the orientation calculation unit 43 calculates the orientation of the user based on the history of the current position of the user 90 calculated by the positioning processing unit 41. Details will be described later.

Based on the position of the mobile terminal 50 (the position of the user 90 who carries the mobile terminal 50) measured at predetermined time intervals, the linear movement detection unit 44 determines whether or not the user 90 is linearly moving. In addition, the linear movement detection unit 44 detects the movement amount and the movement direction of the linear movement of the user 90 when it is determined that the user 90 is linearly moving. In addition, in a case where it is determined that the user 90 is linearly moving, the linear movement detection unit 44 outputs a linear movement detection signal indicating that the user 90 is linearly moving to the orientation calculation unit 43. Note that, in a case where it is determined that the position of the user 90 who carries the mobile terminal 50 has linearly moved after the behavior measurement device 20a starts the processing, the linear movement detection unit 44 stores that it is determined that the user 90 has linearly moved.

The addition unit 45 adds an integrated value W (see FIG. 8) of the angular velocity ω output from the rotational movement detection unit 42 and a movement direction θ₀ (see FIG. 8) of the user 90 output from the linear movement detection unit 44.

The operation control unit 49 controls the progress of the entire processing performed by the behavior measurement device 20a.

[1-4. Operation of Behavior Measurement Device]

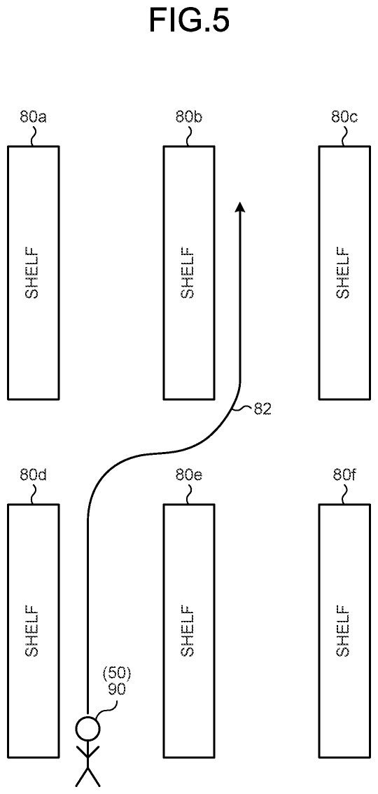

Next, an operation performed by the behavior measurement device 20a of the first embodiment will be described in detail with reference to FIG. 5. FIG. 5 is a diagram illustrating an example of an application scene of the behavior measurement system of the first embodiment.

FIG. 5 illustrates a state in which the user 90 who carries the mobile terminal 50 is shopping in a general store while walking between shelves 80a, 80b, 80c, 80d, 80e, and 80f arranged in the store and on which products are displayed. The behavior measurement system 10a measures the behavior (movement trajectory and orientation) of the user 90 in such a scene, analyzing the behavior of the user 90 at the time of shopping, and improving a method of displaying products and the like.

In the scene illustrated in FIG. 5, the user 90 generally searches for products displayed on the shelves 80a, 80b, 80c, 80d, 80e, and 80f while linearly moving along the shelves 80a, 80b, 80c, 80d, 80e, and 80f. That is, the user 90 moves, for example, along a movement route 82. Then, since the user 90 carries the mobile terminal 50 in a pocket and the like, the mobile terminal 50 also moves along the same movement route 82 as the user 90.

Then, the behavior measurement device 20a detects that the user 90 has moved along the movement route 82 by tracing the current position of the mobile terminal 50. Specifically, the behavior measurement device 20a detects the movement route of the user 90 based on the outputs of the magnetic sensor 52, the acceleration sensor 54, and the gyro sensor 56. At this time, a difference between the current positions of mobile terminals 50 at different times represents the movement amount and the movement direction of the user 90.

The user 90 directs his/her body toward the shelves in order to search for products displayed on the shelves 80a, 80b, 80c, 80d, 80e, and 80f while moving. At this time, the mobile terminal 50 carried by the user 90 also changes its orientation according to the change in the orientation of the body of the user 90.

Therefore, it is considered that the direction obtained by adding the integrated value of the angular velocity detected by the gyro sensor 56 to the movement direction of the user 90 detected at that point of time is the orientation of the user 90.

[1-5. Method of Calculating Movement Direction]

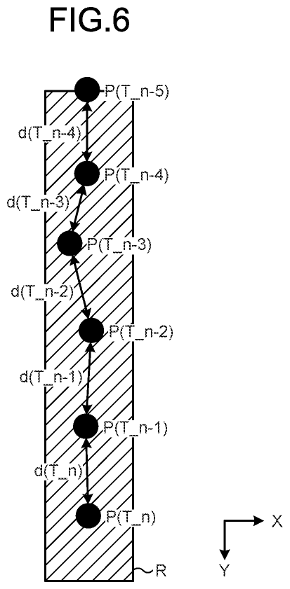

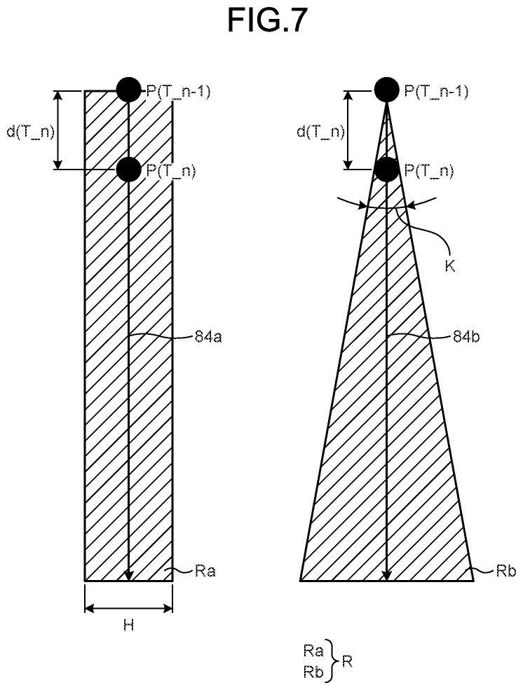

Next, a method in which the behavior measurement device 20a of the first embodiment calculates the movement direction of the user 90 will be described with reference to FIGS. 6 and 7. FIG. 6 is a first diagram for describing a method of detecting linear movement. FIG. 7 is a second view for describing a method of detecting linear movement.

The linear movement detection unit 44 detects whether the user 90 who carries the mobile terminal 50 is linearly moving based on the position information of the mobile terminal 50 detected at a plurality of different times. For example, it is assumed that, while the user 90 is moving along the Y axis in FIG. 6, positions P(T_n), P(T_n−1), P(T_n−2), P(T_n−3), P(T_n−4), and P(T_n−5) of the mobile terminal 50 are detected at each time of times T_n, T_n−1, T_n−2, T_n−3, T_n−4, and T_n−5. Note that n indicates the acquisition timing of the position P. In addition, in the following description, these positions may be collectively referred to simply as a position P.

At this time, the linear movement detection unit 44 determines that the user 90 who carries the mobile terminal 50 is linearly moving on condition that, among the positions P(T_n), P(T_n−1), P(T_n−2), P(T_n−3), P(T_n−4), and P(T_n−5) of the past six points (an example of the predetermined number of times) including the time T_n that is the current time, distance difference values d(T_n), d(T_n−1), d(T_n−2), d(T_n−3), and d(T_n−4) at adjacent positions are all equal to or more than a threshold value dth (for example, 30 cm), and all the positions P(T_n), P(T_n−1), P(T_n−2), P(T_n−3), P(T_n−4), and P(T_n−5) are within a predetermined detection range R. Note that these positions P are stored in the storage device 36 that is a FIFO memory, and the position P at an old time t is deleted each time the position P at a new time t is acquired. In addition, the threshold value dth is an example of a first predetermined value in the present application. Then, the detection range R is an example of a predetermined area in the present application. Note that the number of the positions P in the past to be referred to may be appropriately set according to the type of the behavior measured by the behavior measurement device 20a and the like.

Note that the number of the positions P(T_n) in the past to be referred to and the threshold value of the distance difference value d(T_n) and the shape of the detection range R are appropriately set according to the actual situation to which the behavior measurement system 10a is applied.

The linear movement detection unit 44 sets a detection range R for determining whether the linear movement is performed, for example, as illustrated in FIG. 7. The left diagram of FIG. 7 is an example in which, in a case where the distance difference value d(T_n) between the positions P(T_n) and P(T_n−1) of the mobile terminal 50 at the times T_n and T_n−1 is equal to or more than the above-described threshold value, a rectangular area having a width H along an axis 84a from the position P(T_n−1) toward the position P(T_n) is set as a detection range Ra. In addition, the right diagram of FIG. 7 is an example in which, in a case where the distance difference value d(T_n) between the positions P(T_n) and P(T_n−1) of the mobile terminal 50 at the times T_n and T_n−1 is equal to or more than the above-described threshold value, an isosceles triangle area having an axis 84b from the position P(T_n−1) toward the position P(T_n) as a bisector of a vertex angle K is set as a detection range Rb. Which shape range is set may be determined according to an actual situation to which the behavior measurement system 10a is applied.

[1-6. Method of Calculating Orientation]

Next, a method of detecting the orientation of the user will be described with reference to FIG. 8. FIG. 8 is a diagram for describing a method of detecting an orientation of a user. In particular, FIG. 8 illustrates the history of the past six points of the position P in a case where the linear movement detection unit 44 determines that the user 90 is linearly moving.

It is assumed that the positions P(T_n), P(T_n−1), P(T_n−2), P(T_n−3), P(T_n−4), and P(T_n−5) of the mobile terminal 50 and angular velocities ω(T_n), ω(T_n−1), ω(T_n−2), ω(T_n−3), ω(T_n−4), and ω(T_n−5) of the mobile terminal 50 (gyro sensor 56) are measured at each time of the times T_n, T_n−1, T_n−2, T_n−3, T_n−4, and T_n−5. Note that it is desirable to measure the position P and the angular velocity ω at the same time. However, in a case where the acquisition times of the position P and the angular velocity ω are different from each other, for example, the angular velocity ω at the same time as the time when the position P is measured is estimated by interpolating the angular velocity ω. Note that, in the following description, in order to simplify the description, it is assumed that the position P and the angular velocity ω are simultaneously measured at a sampling time Δt.

The linear movement detection unit 44 determines that the user 90 is linearly moving in a case where the positions P(T_n), P(T_n−1), P(T_n−2), P(T_n−3), P(T_n−4), and P(T_n−5) of the mobile terminal 50 satisfy the conditions described in FIG. 6. Then, the direction of the linear movement is defined as the movement direction θ₀ from the position P(T_n−5) toward the position P(T_n).

In addition, the rotational movement detection unit 42 calculates the integrated value W of the angular velocities ω(T_n), ω(T_n−1), ω(T_n−2), ω(T_n−3), ω(T_n−4), and ω(T_n−5) output from the gyro sensor 56 of the mobile terminal 50. That is, the integrated value W is expressed by Formula (1). Note that the sampling time of the gyro sensor 56 is Δt. In addition, Formula (1) is an example illustrating a method of calculating the integrated value W based on the positions P of the past six points, and the number of positions P to be used in the past is appropriately set.

$$W = {\sum }_{p = n - 5}^{n} ω ( T \_ p ) Δ t \qquad ( 1 )$$

In addition, in a case where the integrated value W exceeds 360°, the integrated value W is reset to W−360°. In addition, in a case where the integrated value W falls below −360°, the integrated value W is reset to W+3600.

Then, when the linear movement detection unit 44 detects the linear movement of the mobile terminal 50, the orientation calculation unit 43 calculates an orientation θ(T_n) of the user 90 by adding the movement direction θ₀ and the integrated value W of the angular velocity ω in the addition unit 45. That is, the orientation θ(T_n) of the user is expressed by Formula (2).

θ(T_n)=θ₀+W (2)

Note that the above-described reset operation is also performed in a case where the user's orientation θ(T_n) exceeds 3600 or in a case where the user's orientation θ(T_n) falls below −360°.

Next, processing performed by the orientation calculation unit 43 in a case where the linear movement detection unit 44 does not determine that the user 90 is linearly moving and determines that the user has linearly moved in the past will be described.

As described above, in a case where the linear movement detection signal is not input to the linear movement detection unit 44 at the present time but the linear movement detection signal has been input in the past, a value obtained by adding ω(T_n)Δt to an orientation θ(T_n−1) of the user one point of time before, that is, the previous orientation θ(T_n−1) is set as the orientation θ(T_n) of the user at the present point of time. That is, the orientation θ(T_n) of the user is expressed by Formula (3).

θ(T_n)=θ(T_n−1)+ω(T_n)Δt (3)

Next, processing performed by the orientation calculation unit 43 in a case where the linear movement detection unit 44 does not determine that the user 90 is linearly moving and determines that the user has not linearly moved also in the past will be described.

In such a case, the linear movement detection signal has never been input to the orientation calculation unit 43. At this time, the orientation calculation unit 43 sets the value output from magnetic sensor 52 as a movement direction θ₁ (not illustrated) of the user 90.

Then, the orientation calculation unit 43 sets the movement direction θ₁ as the orientation θ(T_n) of the user 90.

Note that when the gyro sensor 56 is operated for a long time, the measurement accuracy may deteriorate due to accumulation of a drift error. Therefore, it is desirable to appropriately reset the output of the gyro sensor 56. In the present embodiment, for example, the gyro sensor 56 is reset when the integrated value W is calculated. Note that the gyro sensor 56 may be reset each time the integrated value W is calculated a predetermined number of times, or the gyro sensor 56 may be reset in a case where the operation time of the gyro sensor 56 reaches a predetermined time.

[1-7. Flow of Processing Performed by Behavior Measurement Device]

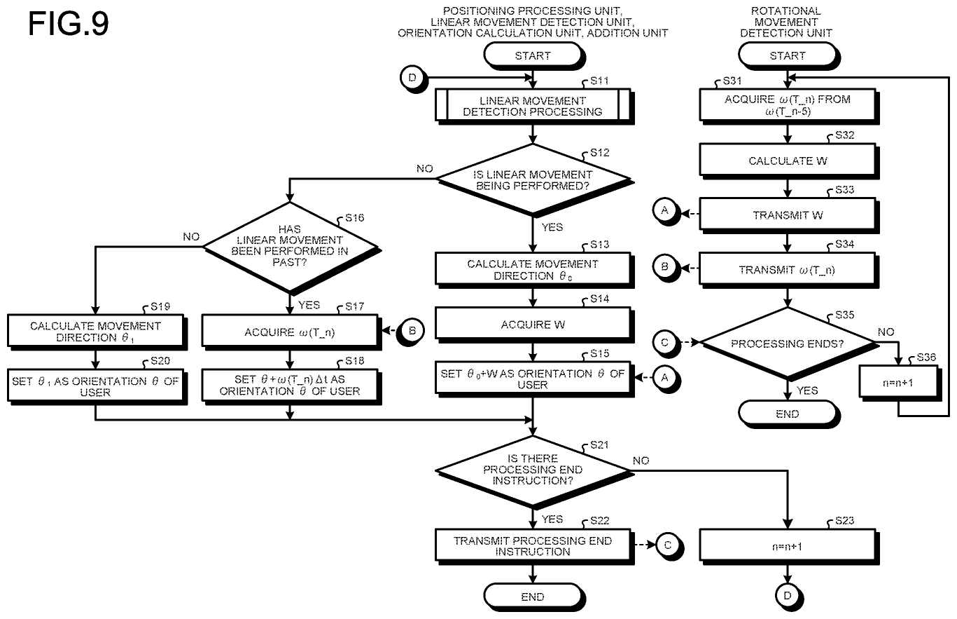

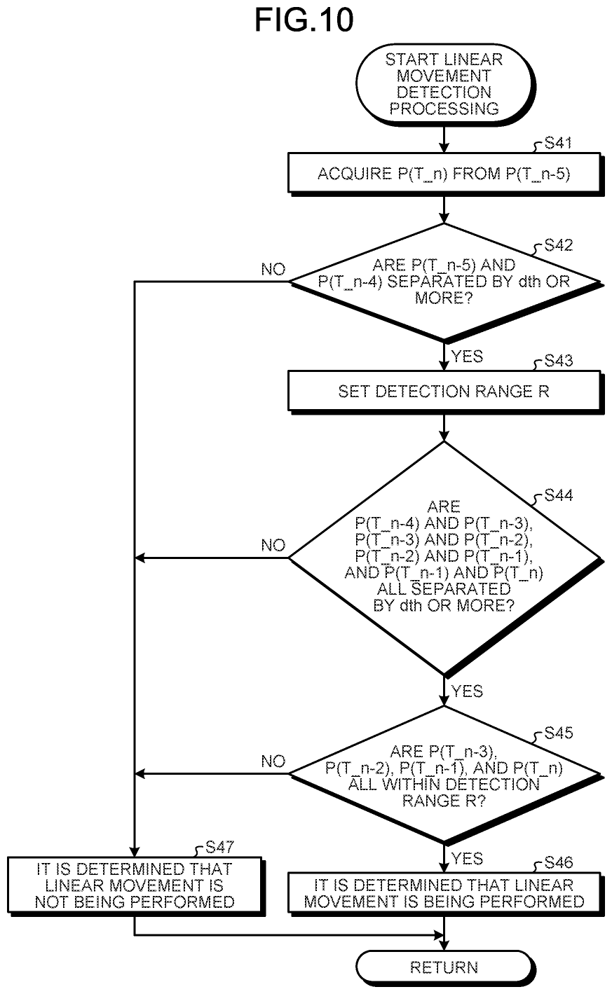

Next, a flow of processing performed by the behavior measurement system 10a of the first embodiment will be described with reference to FIGS. 9 and 10. FIG. 9 is a flowchart illustrating an example of a flow of processing performed by the behavior measurement system of the first embodiment. FIG. 10 is a flowchart illustrating an example of a flow of linear movement detection processing.

The positioning processing unit 41, the linear movement detection unit 44, the orientation calculation unit 43, the rotational movement detection unit 42, and the addition unit 45 operate in cooperation with each other under the control of the operation control unit 49. First, a flow of processing performed by the positioning processing unit 41, the linear movement detection unit 44, the orientation calculation unit 43, and the addition unit 45 will be described.

The linear movement detection unit 44 performs linear movement detection processing (step S11). Details of the linear movement detection processing will be described later (see FIG. 10).

The linear movement detection unit 44 determines whether the position P of the mobile terminal 50 is linearly moving with reference to the result of the linear movement detection processing performed in step S11 (step S12). When it is determined that the position P of the mobile terminal 50 is linearly moving (step S12: Yes), the process proceeds to step S13. On the other hand, when it is not determined that the position P of the mobile terminal 50 is linearly moving (step S12: No), the process proceeds to step S16.

When Yes is determined in step S12, the linear movement detection unit 44 calculates the movement direction θ₀ of the mobile terminal 50 (step S13).

Subsequently, the addition unit 45 acquires the integrated value W of the angular velocity ω from the rotational movement detection unit 42 (step S14).

The orientation calculation unit 43 acquires a result obtained by adding the movement direction θ₀ and the integrated value W of the angular velocity ω by the addition unit 45, and sets the result as an orientation θ of the user 90 (step S15).

The operation control unit 49 determines whether there is a processing end instruction (step S21). When it is determined that there is a processing end instruction (step S21: Yes), the process proceeds to step S22. On the other hand, when it is not determined that there is a processing end instruction (step S21: No), the process proceeds to step S23.

When Yes is determined in step S21, the operation control unit 49 transmits a processing end instruction to the rotational movement detection unit 42 (step S22). After that, the behavior measurement device 20a ends the processing of FIG. 9.

On the other hand, when No is determined in step S21, the linear movement detection unit 44 increments n indicating the acquisition timing of the position P (step S23). After that, the processing returns to step S11, and the above-described processing is repeated.

Returning to step S12, when No is determined in step S12, the linear movement detection unit 44 determines whether the position P of the mobile terminal 50 has linearly moved in the past (step S16). When it is determined that the position P of the mobile terminal 50 has linearly moved in the past (step S16: Yes), the process proceeds to step S17. On the other hand, when it is determined that the position P of the mobile terminal 50 has not linearly moved in the past (step S16: No), the process proceeds to step S19.

When Yes is determined in step S16, the orientation calculation unit 43 acquires the angular velocity ω(T_n) from the rotational movement detection unit 42 (step S17).

Then, the orientation calculation unit 43 sets the sum of the previous orientation θ of the user 90, the angular velocity ω(T_n), and the integrated value of the sampling time Δt as the current orientation θ of the user 90 (step S18). After that, the process proceeds to step S21.

On the other hand, when No is determined in step S16, the positioning processing unit 41 calculates the movement direction θ₁ of the mobile terminal 50 (step S19).

Then, the orientation calculation unit 43 sets the movement direction θ₁ as the orientation θ of the user 90 (step S20). After that, the process proceeds to step S21.

Here, the flow of the linear movement detection processing will be described with reference to FIG. 10.

The linear movement detection unit 44 acquires positions P(T_n−5), P(T_n−4), P(T_n−3), P(T_n−2), P(T_n−1), and P(T_n) of the mobile terminal 50 from the positioning processing unit 41 (step S41).

The linear movement detection unit 44 determines whether the position P(T_n−5) and the position P(T_n−4) are separated by the threshold value dth or more (step S42). When it is determined that the position P(T_n−5) and the position P(T_n−4) are separated by the threshold value dth or more (step S42: Yes), the process proceeds to step S43. On the other hand, when it is not determined that the position P(T_n−5) and the position P(T_n−4) are separated by the threshold value dth or more (step S42: No), the process proceeds to step S47.

When Yes is determined in step S42, the linear movement detection unit 44 sets the detection range R for determining whether the mobile terminal 50 is linearly moving based on the position P(T_n−5) and the position P(T_n−4) (step S43).

Next, the linear movement detection unit 44 determines whether the positions P(T_n−4) and P(T_n−3), P(T_n−3) and P(T_n−2), P(T_n−2) and P(T_n−1), and P(T_n−1) and P(T_n) are all separated by the threshold value dth or more (step S44). When it is determined that all are separated by the threshold value dth or more (step S44: Yes), the process proceeds to step S45. On the other hand, when it is not determined that all are separated by the threshold value dth or more (step S44: No), the process proceeds to step S47.

When Yes is determined in step S44, the linear movement detection unit 44 determines whether all the positions P(T_n−3), P(T_n−2), P(T_n−1), and P(T_n) are within the detection range R (step S45). When it is determined that all are within the detection range R (step S45: Yes), the process proceeds to step S46. On the other hand, when it is not determined that all are within the detection range R (step S45: No), the process proceeds to step S47.

When Yes is determined in step S45, the linear movement detection unit 44 determines that the position P of the mobile terminal 50 is linearly moving (step S46). After that, the process returns to the main routine in FIG. 9.

On the other hand, when No is determined in steps S42, S44, and S45, the linear movement detection unit 44 determines that the position P of the mobile terminal 50 is not linearly moving (step S47). After that, the process returns to the main routine in FIG. 9.

Returning to FIG. 9 again, a flow of processing performed by the rotational movement detection unit 42 will be described. The rotational movement detection unit 42 acquires angular velocities ω(T_n−5), ω(T_n−4), ω(T_n−3), ω(T_n−2), ω(T_n−1), and ω(T_n) from the sensor signal acquisition unit 40 (step S31).

The rotational movement detection unit 42 calculates the integrated value W of the angular velocity ω (step S32).

The rotational movement detection unit 42 transmits the integrated value W to the addition unit 45 (step S33).

The rotational movement detection unit 42 transmits the angular velocity ω(T_n) to the orientation calculation unit 43 (step S34).

The rotational movement detection unit 42 determines whether the processing end instruction has been received from the operation control unit 49 (step S35). When it is determined that the processing end instruction has been received (step S35: Yes), the rotational movement detection unit 42 ends the processing of FIG. 9. On the other hand, when it is not determined that the processing end instruction has received (step S35: No), the process proceeds to step S36.

When No is determined in step S35, the rotational movement detection unit 42 increments n indicating the acquisition timing of the position P, and waits for the next timing at which the next angular velocity ω is acquired from the sensor signal acquisition unit 40 (step S36). After that, the processing returns to step S31, and the above-described each processing is repeated.

Note that, although not illustrated in FIG. 9, for example, in a case where the magnetic sensor 52 loses its own position, the behavior measurement system 10a may redo the processing of FIG. 9 from the beginning.

[1-8. Effects of First Embodiment]

As described above, in the behavior measurement device 20a (information processing device) of the first embodiment, the linear movement detection unit 44 determines, based on the position P of the user 90 measured at predetermined time intervals, whether or not the user 90 is linearly moving and detects the movement amount and the movement direction θ₀ of the linear movement of the user 90. The rotational movement detection unit 42 detects an amount of change in the orientation of the user 90. Then, in a case where it is determined that the user 90 is linearly moving, the orientation calculation unit 43 calculates the orientation θ of the user 90 at the position where the user is determined to be linearly moving based on the detection result of the rotational movement detection unit 42.

As a result, even in a state where there is no limitation on the movement route, the position P and the orientation θ of the user 90 can be accurately detected.

In addition, in the behavior measurement device 20a (information processing device) of the first embodiment, in a case where it is not determined that the user 90 is linearly moving and it is determined that the user 90 has linearly moved in the past, the orientation calculation unit 43 calculates the orientation θ of the user 90 at the current point of time by adding the integrated value W (amount of change in orientation) of the angular velocity to of the user 90 detected by the rotational movement detection unit 42 and the orientation θ of the user 90 at the previous position during a period from the previous position to the current position of the user 90.

As a result, the orientation θ of the user 90 can be easily and accurately detected.

In addition, in the behavior measurement device 20a (information processing device) of the first embodiment, the orientation calculation unit 43 determines that the user 90 has linearly moved on the condition that the amount of change in the position of the user 90 detected by the linear movement detection unit 44 continuously exceeds the threshold value dth (first predetermined value) a predetermined number of times and that all the positions P detected the predetermined number of times are included in the detection range R (predetermined area).

As a result, it is possible to detect that the user 90 has linearly moved with a simple detection logic without giving a constraint such as passing a specific position to the user 90.

In addition, in the behavior measurement device 20a (information processing device) of the first embodiment, the linear movement detection unit 44 further sets the shape of the detection range R (predetermined area).

As a result, it is possible to set an appropriate detection range R for determining whether the user 90 has linearly moved according to an actual situation to which the behavior measurement system 10a is applied.

In addition, in the behavior measurement device 20a (information processing device) of the first embodiment, in a case where it is not determined that the user 90 is linearly moving, the orientation calculation unit 43 sets the movement direction θ₁ based on the position P of the user 90 detected by the positioning processing unit 41 as the orientation θ of the user 90.

As a result, even in a case where the user 90 is not linearly moving, the orientation θ of the user 90 can be calculated.

In addition, in the behavior measurement device 20a (information processing device) of the first embodiment, the position P and the angular velocity ω of the user 90 are measured by the mobile terminal 50 carried by the user 90.

As a result, as long as the user 90 carries the mobile terminal 50, the behavior measurement device 20a can acquire the movement behavior of the user 90 without making the user 90 aware of the presence of the sensor.

In addition, in the behavior measurement device 20a (information processing device) of the first embodiment, the position P of the user 90 is measured by at least the magnetic sensor 52.

As a result, the position P of the user 90 who carries the mobile terminal 50 can be easily and reliably detected.

In addition, in the behavior measurement device 20a (information processing device) of the first embodiment, the position P of the user 90 is measured based on the output of the magnetic sensor 52, the output of the acceleration sensor 54, and the output of the gyro sensor 56.

As a result, the current position of the mobile terminal 50 can be more efficiently detected because the current position of the mobile terminal 50 is near the position obtained by adding the value based on the magnitude and direction of the outputs of the acceleration sensor 54 and the gyro sensor 56 to the previous position of the mobile terminal detected by the magnetic sensor 52.

In addition, in the behavior measurement device 20a (information processing device) of the first embodiment, the orientation θ of the user is measured by integrating the outputs of the gyro sensor 56.

As a result, the orientation θ of the user can be measured easily and with high accuracy.

### 2. Second Embodiment

In the behavior measurement system 10a described in the first embodiment, the behavior measurement device 20a detects the movement behavior of the user 90 by the above-described processing logic. Therefore, it is necessary to set an appropriate threshold value dth (first predetermined value) and the detection range R by performing evaluation experiments and the like on many users 90. In contrast, in a behavior measurement device 20b included in a behavior measurement system 10b (not illustrated) of the second embodiment, machine learning is applied to determination of linear movement performed by the linear movement detection unit 44 of the behavior measurement device 20a. This eliminates the need for the behavior measurement device 20b to set the threshold value dth (first predetermined value) and the detection range R when the linear movement of the user 90 is detected. Note that the behavior measurement device 20b is an example of an information processing device in the present disclosure.

[2-1. Outline of Behavior Measurement Device]

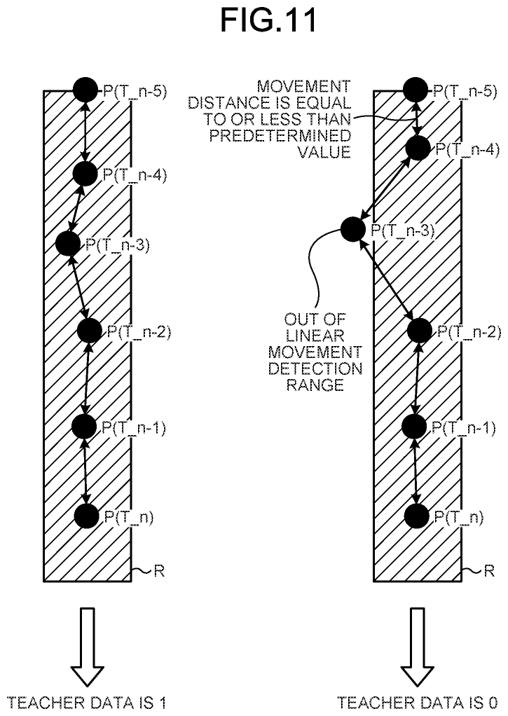

Learning processing performed by the behavior measurement device 20b of the second embodiment will be described with reference to FIG. 11. FIG. 11 is a diagram illustrating an outline of learning processing performed by a behavior measurement device of a second embodiment.

Before using the behavior measurement device 20b, it is necessary to cause a plurality of users 90 to actually use the behavior measurement system 10b to learn what kind of motion the users 90 make when it should be determined that the users 90 have linearly moved.

For example, as illustrated in the left diagram of FIG. 11, in a case where the movement trajectory of the position P of the user 90 over a predetermined time range falls within the predetermined detection range R and a distance difference value d is equal to or more than a predetermined distance (threshold value dth), the behavior measurement device 20b determines that the user has linearly moved. At this time, the behavior measurement device 20b outputs teacher data “1”. That is, the method of determining that the user 90 has linearly moved is the same as that in the first embodiment.

On the other hand, as illustrated in the right diagram of FIG. 11, in a case where the movement trajectory of the position P of the user 90 over a predetermined time range does not fall within the predetermined detection range R and at least one distance difference value d is not equal to or more than a predetermined distance (threshold value dth), the behavior measurement device 20b determines that the user has not linearly moved. At this time, the behavior measurement device 20b outputs teacher data “0”. That is, the method of determining that the user 90 has not linearly moved is the same as that in the first embodiment.

The calculated teacher data is accumulated in the behavior measurement device 20b to form a network that outputs a signal indicating whether or not the user 90 has linearly moved when the position P of the user 90 is input. Then, by performing the above-described learning for a certain number of users 90, the network is strengthened, and highly reliable determination can be made. Note that the form of the network is not limited.

[2-2. Functional Configuration of Behavior Measurement Device]

The behavior measurement system 10b of the second embodiment has a configuration in which the behavior measurement device 20a is replaced with the behavior measurement device 20b in the behavior measurement system 10a described in the first embodiment.

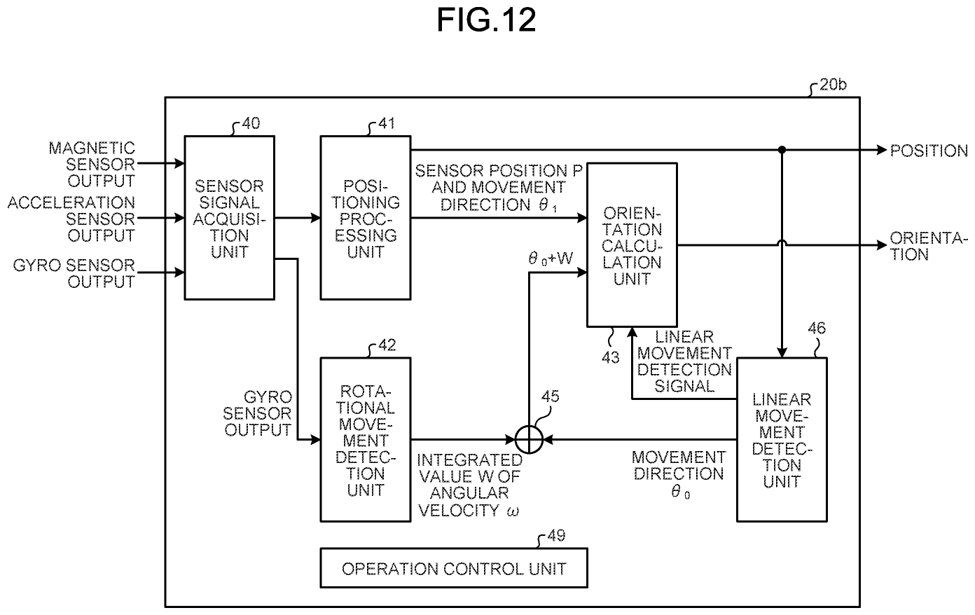

A functional configuration of the behavior measurement device 20b of the second embodiment will be described with reference to FIG. 12. FIG. 12 is a functional block diagram illustrating an example of a functional configuration of the behavior measurement device of the second embodiment. The behavior measurement device 20b includes a linear movement detection unit 46 instead of the linear movement detection unit 44 included in the behavior measurement device 20a.

The linear movement detection unit 46 acquires the position P of the user 90 measured at predetermined time intervals from the positioning processing unit 41, and inputs the position P to the learned network. Then, the linear movement detection unit 46 determines whether the position P of the user 90 is linearly moving using the learned network. Then, in a case where it is determined that the user 90 is linearly moving, the linear movement detection unit 46 outputs a linear movement detection signal indicating that the user 90 is linearly moving to the orientation calculation unit 43. Furthermore, in a case where it is determined that the position P of the user 90 is linearly moving, the linear movement detection unit 46 outputs the movement direction θ₀ of the user 90. Note that the linear movement detection unit 46 is an example of a learning unit and a linear movement detection unit in the present disclosure.

The functions of the other constituent parts are the same as those of the behavior measurement device 20a. That is, the addition unit 45 adds the integrated value W of the angular velocity ω output from the rotational movement detection unit 42 and the movement direction θ₀ of the user 90 output from the linear movement detection unit 46. Then, in a case of acquiring the linear movement detection signal from the linear movement detection unit 46, the orientation calculation unit 43 sets the addition result of the addition unit 45 as the orientation θ of the user 90.

[2-3. Flow of Processing Performed by Behavior Measurement Device]

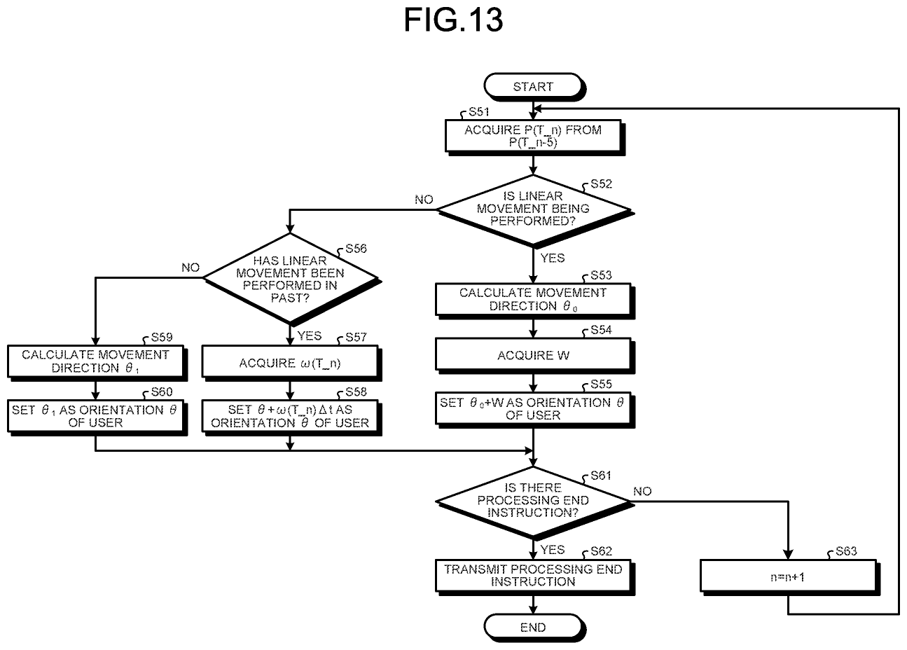

Next, a flow of processing performed by the behavior measurement system 10b of the second embodiment will be described with reference to FIG. 13. FIG. 13 is a flowchart illustrating an example of a flow of processing performed by the behavior measurement system of the second embodiment.

The positioning processing unit 41, the linear movement detection unit 46, the orientation calculation unit 43, the rotational movement detection unit 42, and the addition unit 45 operate in cooperation with each other under the control of the operation control unit 49. Note that it is assumed that the behavior measurement device 20b has completed learning for determining linear movement of the user 90, and the formed network is stored in the linear movement detection unit 46.

The linear movement detection unit 46 acquires positions P(T_n−5), P(T_n−4), P(T_n−3), P(T_n−2), P(T_n−1), and P(T_n) of the mobile terminal 50 from the positioning processing unit 41 (step S51). The acquired position P of the mobile terminal 50 is input to a network that is stored in the linear movement detection unit 46, is formed by machine learning, and determines whether or not the mobile terminal is linearly moving.

The linear movement detection unit 46 determines whether the positions P(T_n−5), P(T_n−4), P(T_n−3), P(T_n−2), P(T_n−1), and P(T_n) of the mobile terminal 50 acquired in step S51 are linearly moving according to the output of the network (step S52). When it is determined that the position P of the mobile terminal 50 is linearly moving (step S52: Yes), the process proceeds to step S53. On the other hand, when it is not determined that the position P of the mobile terminal 50 is linearly moving (step S52: No), the process proceeds to step S56.

Since subsequent processing is the same as the flow of processing described in the first embodiment (see FIG. 9), description is omitted. In addition, since the rotational movement detection unit 42 performs the same operation as that described in the first embodiment (see FIG. 9), the description is omitted.

[2-4. Effects of Second Embodiment]

As described above, in the behavior measurement device 20b (information processing device) of the second embodiment, the linear movement detection unit 46 (learning unit) learns whether the user 90 has linearly moved based on the position P of the user 90 measured at predetermined time intervals. Then, the linear movement detection unit 46 determines, using the result learned by the linear movement detection unit 46 and based on the position P of the user 90 measured at predetermined time intervals, whether or not the user 90 is linearly moving and detects the movement amount and the movement direction θ₀ of the linear movement of the user 90.

This makes it unnecessary to set the threshold value dth (first predetermined value) and the detection range R when the linear movement of the user 90 is detected.

### 3. Third Embodiment

In the behavior measurement system 10a described in the first embodiment, in a case where the user 90 stops in the middle of the linear movement, the behavior measurement device 20a terminates the determination as to whether or not the user 90 is linearly moving at that point of time. Therefore, in a case where the mobile terminal 50 carried by the user 90 repeatedly stops while outputting the number of positions P necessary for determining whether or not the mobile terminal 50 is linearly moving, the movement trajectory of the user 90 cannot be accurately measured. In contrast, in a case where it is determined that the user 90 has stopped, a behavior measurement device 20c included in a behavior measurement system 10c (not illustrated) of the third embodiment determines whether or not the user 90 has linearly moved based on the movement trajectory of the position P before and after the stop. Note that the behavior measurement device 20c is an example of an information processing device in the present disclosure.

[3-1. Outline of Behavior Measurement Device]

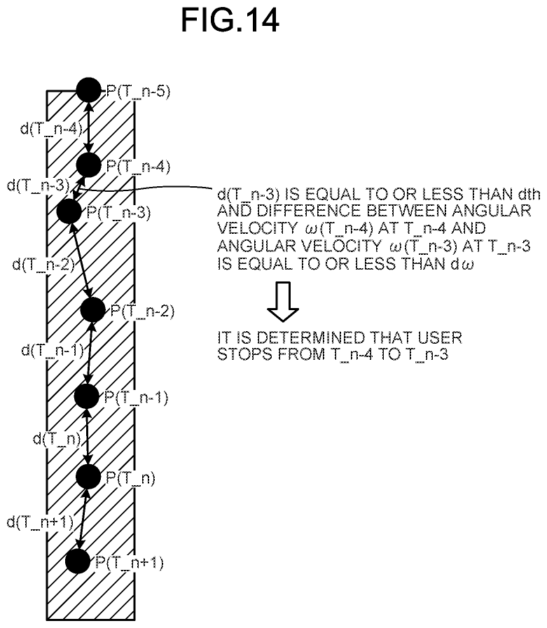

An action of the behavior measurement device 20c of the third embodiment will be described with reference to FIG. 14. FIG. 14 is a diagram illustrating an outline of learning processing performed by a behavior measurement device of a third embodiment.

In FIG. 14, it is assumed that the mobile terminal 50 carried by the user 90 outputs positions P(T_n−5), P(T_n−4), P(T_n−3), P(T_n−2), P(T_n−1), P(T_n), and P(T_n+1). Then, it is assumed that the distance difference value d(T_n−3) between the position P(T_n−4) and the position P(T_n−3) is equal to or less than the threshold value dth (first predetermined value).

At this time, in a case where a difference between the angular velocity ω(T_n−4) of the gyro sensor 56 at the time T_n−4 and the angular velocity ω(T_n−3) of the gyro sensor 56 at the time T_n−3 is equal to or less than the threshold value do, the behavior measurement device 20c determines that the user 90 has stopped during a period from the time T_n−4 to the time T_n−3. Note that the threshold value do is an example of a second predetermined value in the present application.

Then, in a case where it is determined that the user 90 has stopped between the time T_n−4 and the Time T_n−3, the behavior measurement device 20c excludes the position P where the distance difference value d is less than the threshold value dth from candidates for detecting linear movement. That is, in the example of FIG. 14, the linear movement is detected based on the movement trajectory of six points of positions P(T_n−5), P(T_n−4), P(T_n−2), P(T_n−1), P(T_n), and P(T_n+1) excluding the position P(T_n−3).

[3-2. Functional Configuration of Behavior Measurement Device]

The behavior measurement system 10c of the third embodiment has a configuration in which the behavior measurement device 20a is replaced with the behavior measurement device 20c in the behavior measurement system 10a described in the first embodiment.

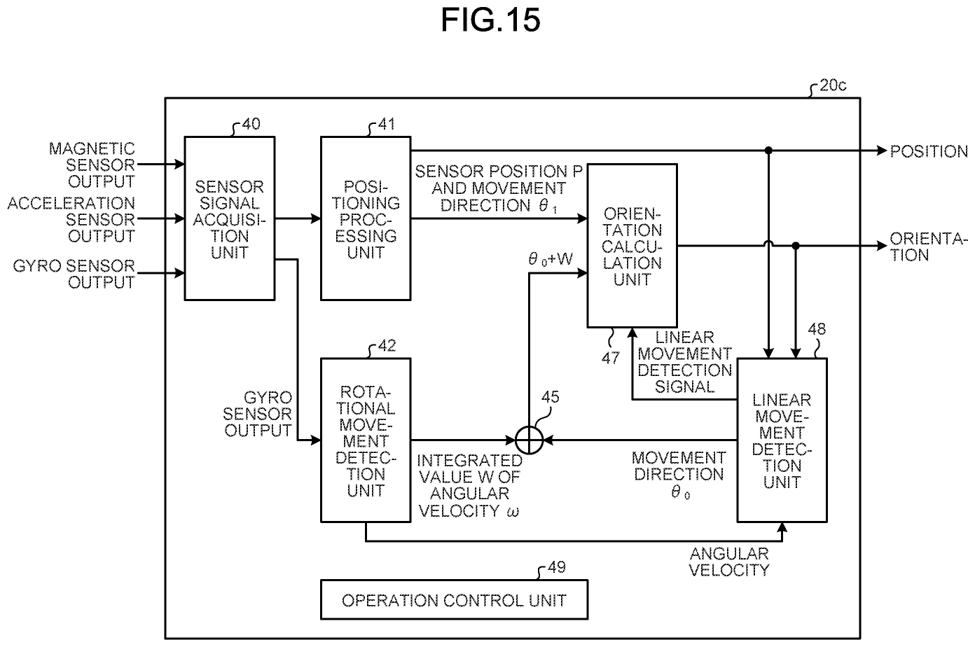

A functional configuration of the behavior measurement device 20c of the third embodiment will be described with reference to FIG. 15. FIG. 15 is a functional block diagram illustrating an example of a functional configuration of the behavior measurement device of the third embodiment. The behavior measurement device 20c includes a linear movement detection unit 48 instead of the linear movement detection unit 44 included in the behavior measurement device 20a. In addition, an orientation calculation unit 47 is provided instead of the orientation calculation unit 43.

Based on the position P of the mobile terminal 50 measured at predetermined time intervals, the linear movement detection unit 48 determines whether or not the user 90 is linearly moving. In addition, the linear movement detection unit 48 detects the movement amount and the movement direction of the linear movement of the user 90 when it is determined that the user 90 is linearly moving. In addition, in a case where it is determined that the user 90 is linearly moving, the linear movement detection unit 48 outputs a linear movement detection signal indicating that the user 90 is linearly moving to the orientation calculation unit 47. Furthermore, in a case where the distance difference value d (amount of change in position) of the position of the position P of the user 90 is equal to or less than the threshold value dth (first predetermined value), and the amount of change in the outputs of the rotational movement detection unit 42 at the two positions P exhibiting the distance difference value d is equal to or less than the threshold value do (second predetermined value), the linear movement detection unit 48 determines that the user 90 stops between the two positions P exhibiting the distance difference value d.

Note that, in a case where it is determined that the user 90 has stopped, the linear movement detection unit 48 determines whether the user 90 has linearly moved based on the position P of the user 90 measured at predetermined time intervals before and after the two positions P determined to have stopped.

In a case where it is determined that the user 90 is linearly moving based on the detection result of the linear movement detection unit 48, that is, in a case where a linear movement detection signal is input from the linear movement detection unit 48, the orientation calculation unit 47 calculates the orientation θ of the user 90 at a position where the user 90 is determined to be linearly moving based on the movement direction of the user 90 and the integrated value of the angular velocity ca detected by the rotational movement detection unit 42. A specific method of calculating the orientation θ is as described in the first embodiment.

The functions of the other constituent parts are the same as those of the behavior measurement device 20a. That is, the addition unit 45 adds the integrated value W of the angular velocity ω output from the rotational movement detection unit 42 and the movement direction θ₀ of the user 90 output from the linear movement detection unit 48.

[3-3. Flow of Processing Performed by Behavior Measurement Device]

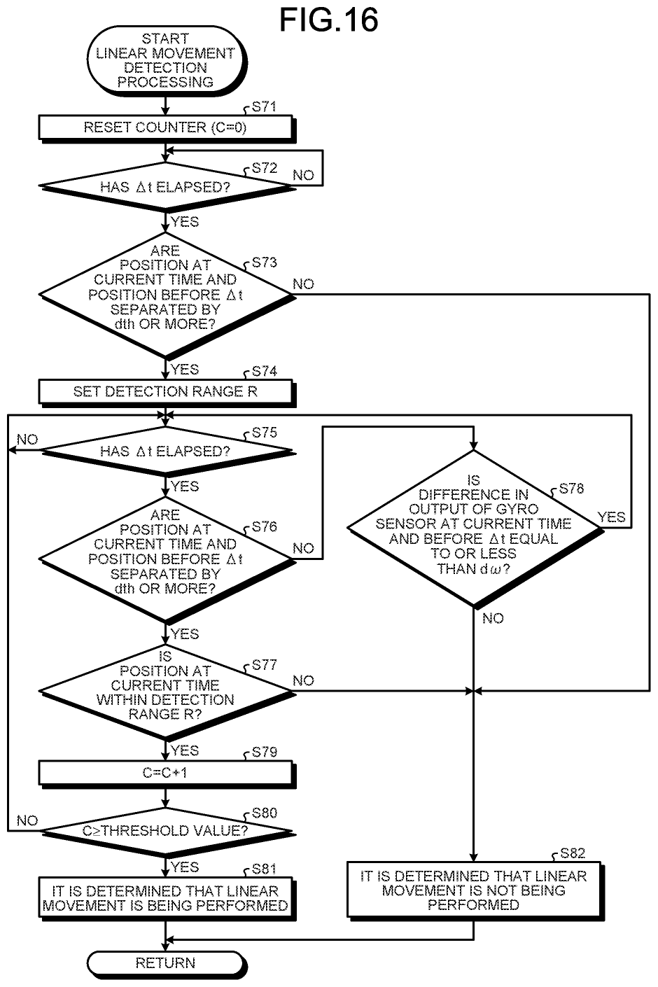

Next, a flow of processing performed by the behavior measurement system 10c of the third embodiment will be described with reference to FIGS. 9 and 16. FIG. 16 is a flowchart illustrating an example of a flow of linear movement detection processing performed by the behavior measurement system of the third embodiment.

Note that the flow of processing performed by the behavior measurement system 10c of the third embodiment is the same as the flow of processing performed by the behavior measurement system 10a described in the first embodiment. However, only the point that the linear movement detection processing illustrated in FIG. 16 is performed instead of the linear movement detection processing (see FIG. 10) described in step S11 of FIG. 9 is different.

Hereinafter, a flow of linear movement detection processing performed by the behavior measurement system 10c will be described with reference to FIG. 16.

The linear movement detection unit 48, the orientation calculation unit 47, the rotational movement detection unit 42, and the addition unit 45 operate in cooperation with each other under the control of the operation control unit 49.

The operation control unit 49 resets a counter value C for counting the number of acquired positions P (step S71).

The operation control unit 49 determines whether the timing of acquiring the position P has come, that is, whether the sampling time Δt has elapsed from the previous acquisition (step S72). When it is determined that the sampling time Δt has elapsed (step S72: Yes), the process proceeds to step S73. On the other hand, when it is not determined that the sampling time Δt has elapsed (step S72: No), step S72 is repeated.

When Yes is determined in step S72, the linear movement detection unit 48 determines whether the position P at the current time and the position P before the sampling time Δt are separated by the threshold value dth or more (step S73). When it is determined that the position P at the current time and the position P before the sampling time Δt are separated by the threshold value dth or more (step S73: Yes), the process proceeds to step S74. On the other hand, when it is not determined that the position P at the current time and the position P before the sampling time Δt are separated by the threshold value dth or more (step S73: No), the process proceeds to step S82.

When Yes is determined in step S73, the linear movement detection unit 48 sets the detection range R for determining whether the mobile terminal 50 is linearly moving based on the position P at the current time and the position P before the sampling time Δt (step S74)

The operation control unit 49 determines whether sampling time Δt has elapsed (step S75). When it is determined that the sampling time Δt has elapsed (step S75: Yes), the process proceeds to step S76. On the other hand, when it is not determined that the sampling time Δt has elapsed (step S75: No), step S75 is repeated.

When Yes is determined in step S75, the linear movement detection unit 48 determines whether the position P at the current time and the position P before the sampling time Δt are separated by the threshold value dth or more (step S76). When it is determined that the position P at the current time and the position P before the sampling time Δt are separated by the threshold value dth or more (step S76: Yes), the process proceeds to step S77. On the other hand, when it is not determined that the position P at the current time and the position P before the sampling time Δt are separated by the threshold value dth or more (step S76: No), the process proceeds to step 378.

When Yes is determined in step S76, the linear movement detection unit 48 determines whether the position P at the current time is within the detection range R (step S77). When it is determined that the position P at the current time is within the detection range R (step S77: Yes), the process proceeds to step S79. On the other hand, when it is not determined that the position P at the current time is within the detection range R (step S77: No), the process proceeds to step S82.

When Yes is determined in step S77, the operation control unit 49 increments the counter value C for counting the number of acquired positions P (step S79).

Next, the operation control unit 49 determines, based on the counter value C, whether the position P necessary for calculating the movement direction θ₀ of the user 90 has been acquired, that is, whether the counter value C is equal to or more than a threshold value (step 380). When it is determined that the counter value C is equal to or more than the threshold value (step S80: Yes), the process proceeds to step S81. On the other hand, when it is not determined that the counter value C is equal to or more than the threshold value (step S80: No), the process proceeds to step S75.

When Yes is determined in step S80, the linear movement detection unit 48 determines that the position P of the mobile terminal 50 is linearly moving (step S81). After that, the process returns to the main routine in FIG.

Returning to step S76, when No is determined in step S76, the linear movement detection unit 48 acquires the angular velocity ω from the rotational movement detection unit 42, and determines whether the difference in the outputs (that is, the angular velocity ω) of the gyro sensor 56 of the current time and before the sampling time Δt is equal to or less than the threshold value do (step 378). When it is determined that the difference in the outputs of the gyro sensor 56 is equal to or less than the threshold value dω (step S78: Yes), the process returns to step S75. On the other hand, when it is not determined that the difference in the outputs of the gyro sensor 56 is equal to or less than the threshold value dω (step S78: No), the process returns to step S82.

When No is determined in any of steps S73, S77, and S78, the linear movement detection unit 48 determines that the position P of the mobile terminal 50 is not linearly moving (step S82). After that, the process returns to the main routine in FIG. 9.

[3-4. Effects of Third Embodiment]

As described above, in the behavior measurement device 20c (information processing device) of the third embodiment, in a case where the distance difference value d (amount of change in position) of the position of the position P of the user 90 is equal to or less than the threshold value dth (first predetermined value), and the amount of change in the outputs of the rotational movement detection unit 42 at the two positions P exhibiting the distance difference value d are equal to or less than the threshold value do (second predetermined value), the linear movement detection unit 48 determines that the user 90 stops between the two positions P exhibiting the distance difference value d.

As a result, even in a case where the user 90 stops in the middle of moving, the position P and the orientation θ of the user 90 can be accurately detected.

In addition, in the behavior measurement device 20c (information processing device) of the third embodiment, in a case where it is determined that the user 90 has stopped, the linear movement detection unit 48 determines whether the user 90 has linearly moved based on the position P of the user 90 measured at predetermined time intervals before and after the two positions P determined to have stopped.

As a result, even in a case where the user 90 stops in the middle of moving, the position P and the orientation θ of the user 90 can be accurately detected based on the moving state of the position P before and after stopping.

### 4. Application Examples of Present Disclosure

The present disclosure can be used for, for example, behavior analysis of a customer in a store. In addition, the real-time advertisement can be distributed to the customer who visits the store based on the behavior analysis result of the customer. Furthermore, it is possible to immediately provide product information and perform in-store navigation (in-store guidance). In addition, it is possible to visualize the behavior of the employees of the store and to use it for customer service education of the employees.

In addition, the present disclosure can be used to visualize the behavior of employees in a factory, a company, and the like, for example. Then, based on the visualized behavior of employees, it is possible to create an environment and the like in which it is easier to act.

Furthermore, the present disclosure can be used to efficiently run a Plan Do Check Action (PDCA) cycle related to business improvement in a store, a factory, a company, and the like.

Although the present disclosure has been described using some embodiments, these embodiments may be executed in an arbitrary device. In that case, it is sufficient that the device has necessary functional blocks and can obtain necessary information.

In addition, for example, each step of one flowchart may be executed by one device, or may be shared and executed by a plurality of devices. Furthermore, in a case where a plurality of processes is included in one step, the plurality of processings may be executed by one device, or may be shared and executed by a plurality of devices. In other words, a plurality of processings included in one step can also be executed as processings of a plurality of steps. Conversely, the processing described as a plurality of steps can be collectively executed as one step.

In addition, for example, in the program executed by the computer, processing of steps describing the program may be executed in time series in the order described in the present specification, or may be executed in parallel or individually at necessary timing such as when a call is made. That is, as long as there is no contradiction, the processing of each step may be executed in an order different from the above-described order. Furthermore, the processing of steps describing the program may be executed in parallel with the processing of another program, or may be executed in combination with the processing of another program.

In addition, for example, a plurality of techniques related to the present technology can be implemented independently as a single body as long as there is no contradiction. Of course, a plurality of arbitrary present technologies can be applied and implemented. For example, some or all of the present technology described in any embodiment can be implemented in combination with some or all of the present technology described in other embodiments. In addition, some or all of the above-described arbitrary present technology can be implemented in combination with other technologies not described above.

Note that the effects described in the present specification are merely examples and are not limited, and other effects may be provided. In addition, the embodiment of the present disclosure is not limited to the above-described embodiment, and various modifications can be made without departing from the gist of the present disclosure.

For example, the present disclosure can also have the following configurations.

(1)
An information processing device including:
a linear movement detection unit that, based on a position of a user measured at a predetermined time interval, determines whether or not the user is linearly moving and detects a movement amount and a movement direction of a linear movement of the user;
a rotational movement detection unit that detects an amount of change in an orientation of the user; and
an orientation calculation unit that, in a case where the linear movement detection unit determines that the user is linearly moving, calculates the orientation of the user at a position where the linear movement detection unit determines that the user is linearly moving based on a detection result of the rotational movement detection unit.
   (2)
The information processing device according to (1), wherein
the orientation calculation unit calculates the orientation of the user by adding the amount of change in the orientation of the user detected by the rotational movement detection unit and the movement direction of the linear movement at a previous position during a period from the previous position where the user is determined to be linearly moving to a current position.
   (3)
The information processing device according to (1) or (2), wherein
the linear movement detection unit
determines that the user has linearly moved on condition that an amount of change in the position of the user continuously exceeds a first predetermined value for a predetermined number of times and a position detected for the predetermined number of times are all included in a predetermined area.
   (4)
The information processing device according to any one of (1) to (3), wherein
the linear movement detection unit further sets a shape of the predetermined area.
   (5)
The information processing device according to any one of (1) to (4), wherein
the orientation calculation unit calculates the orientation of the user based on the position of the user in a case where it is not determined that the user is linearly moving.
   (6)
The information processing device according to any one of (1) to (5), further including:
a learning unit that learns whether the user has linearly moved based on the position of the user measured at a predetermined time interval, wherein
the linear movement detection unit determines, using a learning result of the learning unit and based on the position of the user measured at a predetermined time interval, whether or not the user is linearly moving and detects the movement amount and the movement direction of the linear movement of the user.
   (7)
The information processing device according to any one of (3) to (5), wherein
the linear movement detection unit determines that the user stops between two positions
in a case where the amount of change in the position of the user is equal to or less than the first predetermined value, and
amounts of change in outputs of the rotational movement detection unit at the two positions exhibiting the amount of change in the position is equal to or less than a second predetermined value.
   (8)
The information processing device according to (7), wherein
the linear movement detection unit
determines whether or not the user has linearly moved based on the position of the user measured at a predetermined time interval before and after the two positions
in a case where it is determined that the user stops between the two positions.
   (9)
The information processing device according to any one of (1) to (8), wherein
amounts of change in the position and the orientation of the user is measured by a mobile terminal carried by the user.
   (10)
The information processing device according to any one of (1) to (9), wherein
the position of the user is measured at least by a magnetic sensor.
   (11)
The information processing device according to (10), wherein
the position of the user is measured based on an output of the magnetic sensor, an output of an acceleration sensor, and an output of a gyro sensor.
   (12)
The information processing device according to (11), wherein
the amount of change in the orientation of the user is measured by integrating the output of the gyro sensor.
   (13)
An information processing method causing a computer to function as:
a linear movement detection step that, based on a position of a user measured at a predetermined time interval, determines whether or not the user is linearly moving and detects a movement amount and a movement direction of a linear movement of the user;
a rotational movement detection step that detects an amount of change in an orientation of the user; and
a calculation step that, in a case where the linear movement detection step determines that the user is linearly moving, calculates the orientation of the user at a position where the linear movement detection step determines that the user is linearly moving based on a detection result of the rotational movement detection step.
   (14)
A program functioning as:
a linear movement detection unit that, based on a position of a user measured at a predetermined time interval, determines whether or not the user is linearly moving and detects a movement amount and a movement direction of a linear movement of the user;
a rotational movement detection unit that detects an amount of change in an orientation of the user; and
an orientation calculation unit that, in a case where the linear movement detection unit determines that the user is linearly moving, calculates the orientation of the user at a position where the linear movement detection unit determines that the user is linearly moving based on a detection result of the rotational movement detection unit.

### REFERENCE SIGNS LIST

10a, 10b, 10c BEHAVIOR MEASUREMENT SYSTEM
20a, 20b, 20c BEHAVIOR MEASUREMENT DEVICE
40 SENSOR SIGNAL ACQUISITION UNIT
41 POSITIONING PROCESSING UNIT
42 ROTATIONAL MOVEMENT DETECTION UNIT
43, 47 ORIENTATION CALCULATION UNIT
44, 48 LINEAR MOVEMENT DETECTION UNIT
45 ADDITION UNIT
46 LINEAR MOVEMENT DETECTION UNIT (LEARNING UNIT, LINEAR MOVEMENT DETECTION UNIT)
49 OPERATION CONTROL UNIT
50 MOBILE TERMINAL
52 MAGNETIC SENSOR
54 ACCELERATION SENSOR
56 GYRO SENSOR
84a, 84b AXIS
90 USER
C COUNTER VALUE
d, d(T_n−4), d(T_n−3), d(T_n−2), d(T_n−1), d(T_n) DISTANCE DIFFERENCE VALUE
dth THRESHOLD VALUE (FIRST PREDETERMINED VALUE)
dω THRESHOLD VALUE (SECOND PREDETERMINED VALUE)
H WIDTH
K VERTEX ANGLE
P, P(T_n−5), P(T_n−4), P(T_n−3), P(T_n−2), P(T_n−1), P(T_n), P(T_n+1) POSITION
R, Ra, Rb DETECTION RANGE (PREDETERMINED AREA)
W INTEGRATED VALUE
ω, ω(T_n−5), ω(T_n−4), ω(T_n−3), ω(T_n−2), ω(T_n−1), ω(T_n) ANGULAR VELOCITY
θ, θ(T_n) ORIENTATION
θ₀, θ₁ MOVEMENT DIRECTION
Δt SAMPLING TIME

1. An information processing device including:
a linear movement detection unit that, based on a position of a user measured at a predetermined time interval, determines whether or not the user is linearly moving and detects a movement amount and a movement direction of a linear movement of the user;
a rotational movement detection unit that detects an amount of change in an orientation of the user; and
an orientation calculation unit that, in a case where the linear movement detection unit determines that the user is linearly moving, calculates the orientation of the user at a position where the linear movement detection unit determines that the user is linearly moving based on a detection result of the rotational movement detection unit.

2. The information processing device according to claim 1, wherein
the orientation calculation unit calculates the orientation of the user by adding the amount of change in the orientation of the user detected by the rotational movement detection unit and the movement direction of the linear movement at a previous position during a period from the previous position where the user is determined to be linearly moving to a current position.

3. The information processing device according to claim 1, wherein
the linear movement detection unit
determines that the user has linearly moved on condition that an amount of change in the position of the user continuously exceeds a first predetermined value for a predetermined number of times and a position detected for the predetermined number of times are all included in a predetermined area.

4. The information processing device according to claim 3, wherein
the linear movement detection unit further sets a shape of the predetermined area.

5. The information processing device according to claim 1, wherein
the orientation calculation unit calculates the orientation of the user based on the position of the user in a case where it is not determined that the user is linearly moving.

6. The information processing device according to claim 1, further including:
a learning unit that learns whether the user has linearly moved based on the position of the user measured at a predetermined time interval, wherein
the linear movement detection unit determines, using a learning result of the learning unit and based on the position of the user measured at a predetermined time interval, whether or not the user is linearly moving and detects the movement amount and the movement direction of the linear movement of the user.

7. The information processing device according to claim 3, wherein
the linear movement detection unit determines that the user stops between two positions
in a case where the amount of change in the position of the user is equal to or less than the first predetermined value, and
amounts of change in outputs of the rotational movement detection unit at the two positions exhibiting the amount of change in the position is equal to or less than a second predetermined value.

8. The information processing device according to claim 7, wherein
the linear movement detection unit
determines whether or not the user has linearly moved based on the position of the user measured at a predetermined time interval before and after the two positions
in a case where it is determined that the user stops between the two positions.

9. The information processing device according to claim 1, wherein
amounts of change in the position and the orientation of the user is measured by a mobile terminal carried by the user.

10. The information processing device according to claim 1, wherein
the position of the user is measured at least by a magnetic sensor.

11. The information processing device according to claim 10, wherein
the position of the user is measured based on an output of the magnetic sensor, an output of an acceleration sensor, and an output of a gyro sensor.

12. The information processing device according to claim 11, wherein
the amount of change in the orientation of the user is measured by integrating the output of the gyro sensor.

13. An information processing method causing a computer to function as:
a linear movement detection step that, based on a position of a user measured at a predetermined time interval, determines whether or not the user is linearly moving and detects a movement amount and a movement direction of a linear movement of the user;
a rotational movement detection step that detects an amount of change in an orientation of the user; and
a calculation step that, in a case where the linear movement detection step determines that the user is linearly moving, calculates the orientation of the user at a position where the linear movement detection step determines that the user is linearly moving based on a detection result of the rotational movement detection step.

14. A program functioning as:
a linear movement detection unit that, based on a position of a user measured at a predetermined time interval, determines whether or not the user is linearly moving and detects a movement amount and a movement direction of a linear movement of the user;
a rotational movement detection unit that detects an amount of change in an orientation of the user; and
an orientation calculation unit that, in a case where the linear movement detection unit determines that the user is linearly moving, calculates the orientation of the user at a position where the linear movement detection unit determines that the user is linearly moving based on a detection result of the rotational movement detection unit.
